(19) United States
(12) Patent Application Publication
(10) Pub. No.: US 2025/0233827 A1
(43) Pub. Date: Jul. 17, 2025

(54) DATA COMMUNICATION SYSTEM, DATA COMMUNICATION METHOD, AND NON-TRANSITORY COMPUTER READABLE STORAGE MEDIUM

(71) Applicant: DENSO CORPORATION, Kariya-city (JP)

(72) Inventor: Tsuneo NAKATA, Kariya-city (JP)

(21) Appl. No.: 19/017,859

(22) Filed: Jan. 13, 2025

(30) Foreign Application Priority Data
Jan. 16, 2024 (JP) 2024-004601

(51) Int. Cl. H04L 45/74

(52) U.S. Cl. CPC H04L 45/74

(57) ABSTRACT

A data communication system includes: a first communication node having communication interfaces for sending data to a target node via one communication interface; and a second communication node for sending the data to the first communication node, with the one communication interface as a sending destination. The first communication node has a first conversion processing unit that converts a sending source address of the data to be sent to the target node into an address of the second communication node. The second communication node has a second conversion processing unit that converts a sending destination address of the data received from the target node into an address of the one communication interface.

### CROSS REFERENCE TO RELATED APPLICATION

The present application claims the benefit of priority from Japanese Patent Application No. 2024-004601 filed on Jan. 16, 2024. The entire disclosure of the above application is incorporated herein by reference.

### TECHNICAL FIELD

The present disclosure relates to a data communication system for performing data communication between, for example, a client and a server, a data communication method used in the data communication system, and a non-transitory computer readable storage medium for a data communication program executed by a computer in the data communication system.

### BACKGROUND ART

For example, a conceivable technique teaches a system for performing data communication between a mobile network node, which is a client, and a response node, which is a server. In this system, the data communication between a mobile network node and a response node is relayed by a mobile router and a home agent.

### SUMMARY OF INVENTION

According to an example, a data communication system may include: a first communication node having communication interfaces for sending data to a target node via one communication interface; and a second communication node for sending the data to the first communication node, with the one communication interface as a sending destination. The first communication node has a first conversion processing unit that converts a sending source address of the data to be sent to the target node into an address of the second communication node. The second communication node has a second conversion processing unit that converts a sending destination address of the data received from the target node into an address of the one communication interface.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating a schematic configuration example of a data communication system according to a first embodiment of the present disclosure;

FIG. 2 is a block diagram illustrating a schematic configuration example of a data communication system according to a second embodiment of the present disclosure; and

FIG. 3 is a block diagram illustrating a schematic configuration example of a data communication system according to a third embodiment of the present disclosure.

### DETAILED DESCRIPTION

In a conventional system configuration such as that described in the conceivable technique, data is encapsulated between a mobile router and a home agent with adding header information including a sending source address and a sending destination address. Thus, it is possible to execute the data communication with hiding a process such as route selection of the data communication and address change of the interface with respect to the end node such as the mobile network node and the response node.

However, according to the above-described encapsulation process, the addition of the header information increases communication overhead, that is, communication load, and also increases the processing load on the mobile router and the home agent.

The present embodiments provide a data communication system, a data communication method, and a data communication program that can perform data communication while hiding a process such as route selection and address change of the interface with respect to the end node without encapsulating the data, and can suppress an increase in the load associated with data communication.

A data communication system 10 according to the present embodiments includes: a first communication node 40 having a plurality of communication interfaces 40A, 40B and capable of sending data to a target node 30 via any one communication interface selected from the plurality of communication interfaces; and a second communication node 50 capable of sending data to the first communication node via any one communication interface selected from the plurality of communication interfaces. The first communication node has a first conversion processing unit 41 that converts a sending source address of data to be sent to the target node into an address of the second communication node. The second communication node has a second conversion processing unit 51 that converts a sending destination address of data received from the target node into an address of any one communication interface selected from the plurality of communication interfaces.

A data communication method according to the present embodiments is used for a data communication system 10 including: a first communication node 40 having a plurality of communication interfaces 40A, 40B and capable of sending data to a target node 30 via any one communication interface selected from the plurality of communication interfaces; and a second communication node 50 capable of sending data to the first communication node via any one communication interface selected from the plurality of communication interfaces. The data communication method includes: a first conversion process in the first communication node for converting a sending source address of data to be sent to the target node into an address of the second communication node; and a second conversion process in the second communication node for converting a sending destination address of data received from the target node into an address of any one communication interface selected from the plurality of communication interfaces.

A data communication program according to the present embodiments is executed by a computer in a data communication system 10 including: a first communication node 40 having a plurality of communication interfaces 40A, 40B and capable of sending data to a target node 30 via any one communication interface selected from the plurality of communication interfaces; and a second communication node 50 capable of sending data to the first communication node via any one communication interface selected from the plurality of communication interfaces. The data communication program causes the computer to execute: a first conversion process in the first communication node for converting a sending source address of data to be sent to the target node into an address of the second communication node; and a second conversion process in the second communication node for converting a sending destination address of data received from the target node into an address of any one communication interface selected from the plurality of communication interfaces.

According to the data communication system 10, the data communication method, and the data communication program disclosed herein, it is possible to execute bi-directional data communication with hiding a process such as route selection and address change of an interface with respect to an end node by utilizing an address conversion process without encapsulating data. Therefore, compared to the conventional technique that encapsulates data, it is possible to suppress an increase in the load associated with data communication.

Hereinafter, a number of embodiments of a data communication system, a data communication method, and a data communication program according to the present disclosure will be described with reference to the drawings. Elements that are substantially the same in the embodiments are denoted by the same reference numerals, and description thereof will be omitted. In addition, in this disclosure, the term “sending” data includes the process of transmitting data and also includes the process of transferring data.

### First Embodiment

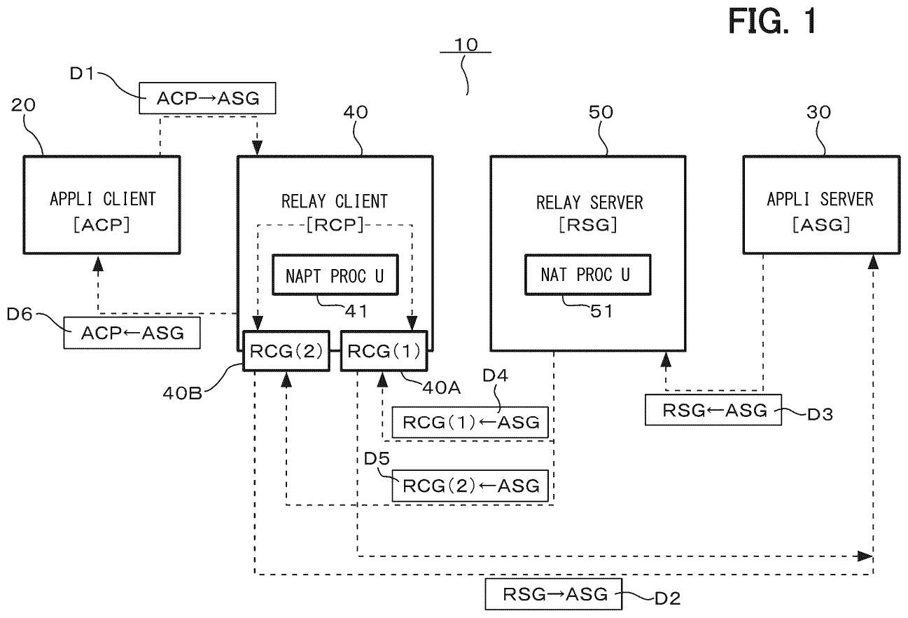

The data communication system 10 illustrated in FIG. 1 is a system that performs data communication between an application client 20 and an application server 30. The application client 20 requests the application server 30 to perform processing using an application. The application server 30 executes the processing by the application in response to the request from the application client 20 and provides the result to the application client 20.

The application server 30 is an example of a target node which is a sending destination of data to be sent by the application client 20. The data communication system 10 includes a relay client 40 and a relay server 50 between an application client 20 and an application server 30. According to the data communication system 10, the data communication between the application client 20 and the application server 30 is relayed by the relay client 40 and the relay server 50.

The relay client 40 is an example of a first communication node. The relay client 40 has a plurality of communication interfaces 40A and 40B. Information indicating what kind of communication interface the relay client 40 has is shared in advance with the relay server 50. The number of communication interfaces included in the relay client 40 is not limited to two, but may be three or more. In this disclosure, for understandable explanation, two communication interfaces 40A, 40B are shown.

The relay client 40 is capable of sending data to the application server 30 via any one communication interface selected from a plurality of communication interfaces 40A and 40B. The relay client 40 mainly includes a computer (not shown) that controls the overall operation of the relay client 40. The relay client 40 executes a data communication program on this computer, thereby virtually realizing the NAPT processing unit 41 by software. The NAPT processing unit 41 may be configured by hardware or a combination of software and hardware.

The NAPT processing unit 41 is an example of the first conversion processing unit, and converts the sending source address of data to be sent to the application server 30 into the address of the relay server 50 by the NAPT processing, which is an example of a first conversion processing. As is well known, the NAPT (i.e., Network Address Port Translation) processing is a process that converts between a local address and a global address, and by also converting the port number of TCP/UDP, it is possible to share a single global address among multiple terminals.

The relay server 50 is an example of the second communication node. The relay server 50 recognizes in advance what type of communication interface the relay client 40 has by sharing information or the like. The relay server 50 is capable of sending data to the relay client 40 via any one of the plurality of communication interfaces 40A and 40B selected as the sending destination. The relay server 50 mainly includes a computer (not shown) that controls the overall operation of the relay server 50. The relay server 50 executes a data communication program on this computer, thereby virtually realizing the NAT processing unit 51 by software. The NAT processing unit 51 may be configured by hardware or a combination of software and hardware.

The NAT processing unit 51 is an example of a second conversion processing unit, and converts the sending destination address of the data received from the application server 30 into the address of one of the communication interfaces selected from the multiple communication interfaces 40A, 40B by the NAT processing, which is an example of a second conversion processing. As is well known, the NAT (i.e., Network Address Translation) processing is a process for converting between a local address and a global address.

Next, the flow of data communication by the data communication system 10 will be described. The application client 20 stores its own local address ACP and the global address ASG of the application server 30 in advance. The application client 20 generates packet data D1 (ACP→ASG) with its own local address ACP as the sending source address and the global address ASG of the application server 30 as the sending destination address, and sends the packet data D1 to the relay client 40.

The relay client 40 receives the packet data D1 (ACP→ASG) from the application client 20, and generates packet data D2 (RSG→ASG) by converting the sending source address ACP of the received packet data D1 (ACP→ASG) into the global address RSG of the relay server 50 using the NAPT processing unit 41. The relay client 40 sends the generated packet data D2 (RSG→ASG) to the application server 30.

At this time, the relay client 40 also performs a process of selecting either the communication interface 40A or the communication interface 40B as the communication interface that will transfer the packet data D2 received at its own local address RCP. That is, the relay client 40 selects one of the multiple communication interfaces 40A, 40B and sends the packet data D2 (RSG→ASG) to the application server 30.

The application server 30 receives the packet data D2 (RSG→ASG) from the relay client 40 and executes processing according to the application. Then, the application server 30 generates packet data D3 (RSG←ASG) for response with which the sending destination is the relay server 50, which is the sending source specified by the received packet data D2 (RSG→ASG). The application server 30 sends the generated packet data D3 (RSG←ASG) to the relay server 50.

The relay server 50 receives the packet data D3 (RSG←ASG) from the application server 30, and generates packet data by converting the sending destination address of the packet data D3 (RSG←ASG) into the global address of a communication interface selected from the multiple communication interfaces 40A, 40B using the NAT processing unit 51. That is, when the relay server 50 selects, for example, the communication interface 40A, the relay server 50 generates packet data D4 (RCG(1)←ASG), and when the relay server 50 selects, for example, the communication interface 40B, the relay server 50 generates packet data D5 (RCG(2)←ASG). The relay server 50 sends the generated packet data D4 (RCG(1)←ASG) or the generated packet data D5 (RCG(2)←ASG) to the relay client 40.

The relay client 40, which has received the packet data D4 (RCG(1)←ASG) or the packet data D5 (RCG(2)←ASG) from the relay server 50, generates packet data D6 (ACP←ASG) by converting the sending destination address of the received packet data D4 (RCG(1)←ASG) or the received packet data D5 (RCG(2)←ASG) into the local address ACP of the application client 20 using the NAPT processing unit 41, and sends the packet data D6 (ACP←ASG) to the application client 20.

According to the first embodiment, the relay client 40 has a plurality of communication interfaces 40A, 40B, and is capable of sending data to the application server 30 via any one of the plurality of communication interfaces 40A, 40B selected therefrom. When sending the data, the relay client 40 converts the sending source address of the data to be sent to the application server 30 into the address of the relay server 50 by the NAPT processing unit 41.

The relay server 50 is capable of sending data to the relay client 40 via any one of the plurality of communication interfaces 40A and 40B selected as the sending destination. When sending the data, the relay server 50 converts the sending destination address of the data received from the application server 30 into the address of one of the communication interfaces 40A, 40B selected by the NAT processing unit 51.

According to this embodiment, even if the data is not encapsulated, it is possible to execute bi-directional data communication with hiding a process such as route selection and/or address change of an interface with respect to an end node by utilizing an address conversion process such as the NAPT process or the NAT process. Therefore, compared to the conventional technique that encapsulates data, it is possible to suppress an increase in the load associated with data communication.

### Second Embodiment

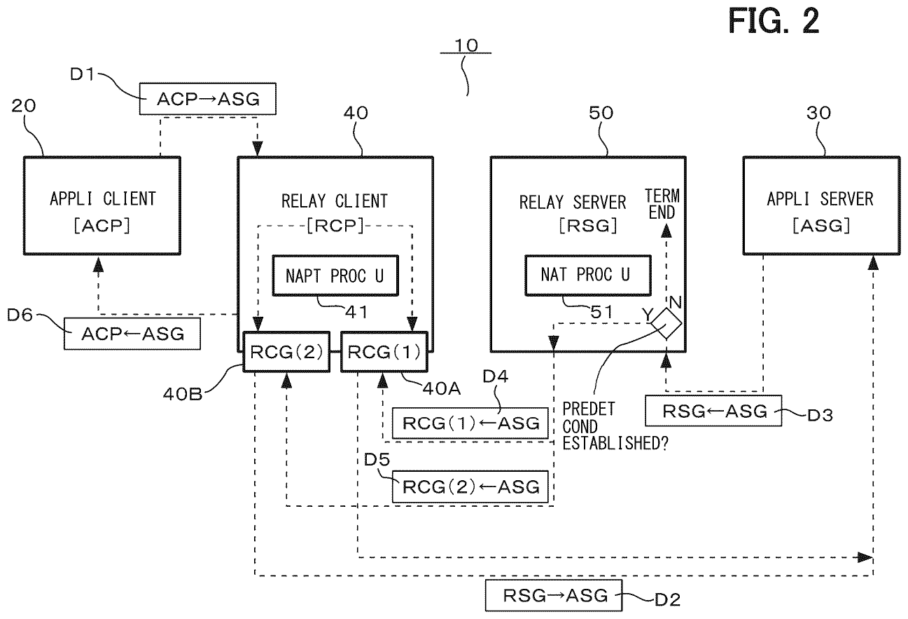

According to the data communication system 10 shown in FIG. 2, the relay server 50 converts, by the NAT processing unit 51, the sending destination address of data that satisfies a predetermined condition among the packet data D3 (RSG←ASG) received from the application server 30, into the address of one of the communication interfaces selected from the multiple communication interfaces 40A, 40B.

In this embodiment, the predetermined condition is set to be a condition “within a predetermined port range.” Therefore, the relay server 50 performs the NAT process only on data of the packet data D3 (RSG←ASG) received from the application server 30, the port number of which is disposed “within the predetermined port range.” In addition, the relay server 50 terminates, within the relay server 50, the data sending of the packet data D3 (RSG←ASG) received from the application server 30, the port number of which is not disposed “within the predetermined port range”, and does not send the data to the relay client 40.

Here, the port number is individually assigned to each of a plurality of applications that the application server 30 can execute, and the port number provides information indicating which application has been executed by the application server 30. Therefore, according to this embodiment, if the application executed on the application server 30 is a specific application, the execution result data is provided to the relay client 40 and ultimately to the application client 20. On the other hand, if the application executed on the application server 30 is not a specific application, the execution result data is not provided to the relay client 40 and thus to the application client 20, but is terminated at the relay server 50.

The information indicating the predetermined condition is always shared between the relay client 40 and the relay server 50. The information indicating the predetermined conditions is updated, for example, periodically to the latest information.

According to the present embodiment, it is possible to utilize address conversion processing without encapsulating data, thereby enabling bi-directional data communication with hiding a process such as route selection and interface address change with respect to the end node, so that it is possible to suppress the increase in the load associated with the data communication. Furthermore, in the relay server 50, the address conversion is performed only on the packet data D3 (RSG←ASG) that satisfies a predetermined condition, so that the processing load of the address conversion in the relay server 50 can be reduced. And, the remaining capacity of the relay server 50 served by the load reduction can be utilized for processes other than the address conversion. The predetermined condition is not limited to the above-described condition of “within a predetermined port range” and other conditions may be set.

### Third Embodiment

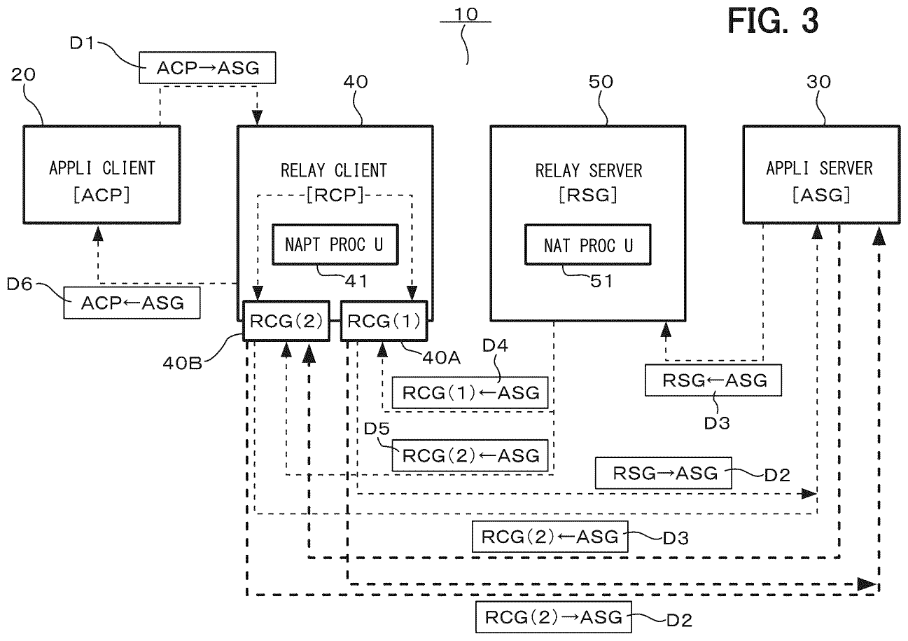

According to the data communication system 10 illustrated in FIG. 3, the relay client 40 can also convert, by the NAPT processing unit 41, the sending source address of the data to be sent to the application server 30 into the address of one of the communication interfaces selected from the multiple communication interfaces 40A, 40B, rather than the address of the relay server 50.

That is, the relay client 40 generates packet data by converting the sending source address ACP of a portion of the packet data D1 (ACP→ASG) received from the application client 20 into the global address of a communication interface selected from the multiple communication interfaces 40A, 40B.

Here, the relay client 40 generates the packet data having the address of one of the communication interfaces as the sending source address even when the relay client 40 selects the communication interface 40A or the relay client 40 selects the communication interface 40B. In the example of FIG. 3, the relay client 40 generates the packet data D2 (RCG(2)→ASG) whose sending source is the communication interface 40B.

The relay client 40 sends the generated packet data D2 (RCG(2)→ASG) to the application server 30. The application server 30 receives the packet data D2 (RCG(2)→ASG) from the relay client 40 and executes processing according to the application. The application server 30 then generates the packet data D3 (RCG(2)←ASG) for response having the sending destination specified by the received packet data D2 (RCG(2)→ASG), and sends the packet data D3 (RCG(2)←ASG) to the relay client 40.

The relay client 40, which has received the packet data D3 (RCG(2) ASG) from the application server 30, generates packet data D6 (ACP←ASG) by converting the sending destination address of the received packet data D3 (RCG(2) ASG) into the local address ACP of the application client 20 using the NAPT processing unit 41, and sends the packet data D6 (ACP←ASG) to the application client 20.

According to the present embodiment, it is possible to utilize address conversion processing without encapsulating data, thereby enabling bi-directional data communication with hiding a process such as route selection and interface address change with respect to the end node, so that it is possible to suppress the increase in the load associated with the data communication. Furthermore, for some of the data received by the relay client 40 from the application client 20, the data communication can be performed on the some of the data without passing through the relay server 50. Therefore, an increase in the processing load, particularly on the relay server 50, can be suppressed.

In addition, the data to be sent from the relay client 40 to the application server 30 without setting the address of the relay server 50 as the sending source address may be, for example, preliminarily determined as the data that does not require processing by the relay server 50. Alternatively, the data to be sent from the relay client 40 to the application server 30 without setting the address of the relay server 50 as the sending source address may be dynamically changed according to various network environment conditions, such as the processing load situation on the relay server 50, the data sending and reception status on the communication line, and requests from applications. The relay client 40 shares information necessary for determining whether the data communication of the reply packet will be performed via the relay server 50 or the data communication of the reply packet will be performed not via the relay server 50, i.e., whether the data communication of the reply packet will be performed without selecting a reply route. The information is updated periodically, for example.

### Other Embodiments

The present disclosure is not limited to the above-described embodiment, and can be modified or expanded as appropriate without departing from the spirit and scope of the present disclosure. For example, the application client 20, the application server 30, the relay client 40, and the relay server 50 may each be one or more. The data communication system 10 may be configured such that other nodes are interposed between the application client 20 and the relay client 40, between the relay client 40 and the relay server 50, and between the relay server 50 and the application server 30.

Although the present disclosure has been described in accordance with the examples, it is understood that the present disclosure is not limited to such examples or structures. The present disclosure incorporates various modifications and variations within a scope of equivalents. In addition, various combinations and forms, and further, other combinations and forms including only one element, or more or less than these elements are also within the sprit and the scope of the present disclosure.

The controller and the techniques thereof according to the present disclosure may be implemented by one or more special-purposed computers. Such a special-purposed computer may be provided (i) by configuring (a) a processor and a memory programmed to execute one or more functions embodied by a computer program, Alternatively, the controller and the method thereof described in the present disclosure may be implemented by a dedicated computer provided by configuring a processor with one or more dedicated hardware logic circuits. Alternatively, the controller and the method thereof described in the present disclosure may be implemented by one or more dedicated computers configured by a combination of a processor and a memory programmed to execute one or more functions and a processor configured by one or more hardware logic circuits. The computer program may be stored in a computer-readable non-transitory tangible storage medium as instructions to be executed by a computer.

Also, the present embodiments further includes the following features in addition to the features described in claims.

Feature 1: A data communication system includes: at least one of (i) a circuit and (ii) a processor having a memory storing computer program code. The at least one of the circuit and the processor having the memory is configured to cause the data communication system to provide: a first communication node having a plurality of communication interfaces and capable of sending data to a target node via one communication interface selected from the plurality of communication interfaces; and a second communication node capable of sending the data to the first communication node, with the one communication interface selected from the plurality of communication interfaces as a sending destination. The first communication node has a first conversion processing unit that converts a sending source address of the data to be sent to the target node into an address of the second communication node. The second communication node has a second conversion processing unit that converts a sending destination address of the data received from the target node into an address of the one communication interface selected from the plurality of communication interfaces.

Feature 2: In the data communication system according to the feature 1, the second communication node converts, by the second conversion processing unit, the sending destination address of the data that satisfies a predetermined condition among the data received from the target node, into the address of the one communication interface selected from the plurality of communication interfaces.

Feature 3: In the data communication system according to the feature 1 or 2, the first communication node can convert, by the first conversion processing unit, the sending source address of the data to be sent to the target node into the address of the one communication interface selected from the plurality of communication interfaces, instead of the address of the second communication node.

Feature 4: A data communication method is used for a data communication system including: at least one of (i) a circuit and (ii) a processor having a memory storing computer program code. The at least one of the circuit and the processor having the memory is configured to cause the data communication system to provide: a first communication node having a plurality of communication interfaces and capable of sending data to a target node via one communication interface selected from the plurality of communication interfaces; and a second communication node capable of sending the data to the first communication node, with the one communication interface selected from the plurality of communication interfaces as a sending destination. The data communication method includes: a first conversion process in the first communication node for converting a sending source address of data to be sent to the target node into an address of the second communication node; and a second conversion process in the second communication node for converting a sending destination address of data received from the target node into an address of one communication interface selected from the plurality of communication interfaces.

Feature 5: In the data communication method according to the feature 4, the second conversion process in the second communication node includes converting the sending destination address of the data that satisfies a predetermined condition among the data received from the target node, into the address of the one communication interface selected from the plurality of communication interfaces.

Feature 6: In the data communication method according to the feature 4 or 5, the first conversion process in the first communication node includes converting the sending source address of the data to be sent to the target node into the address of the one communication interface selected from the plurality of communication interfaces, instead of the address of the second communication node.

Feature 7: A data communication program is executed by a computer in a data communication system including: a first communication node having a plurality of communication interfaces and capable of sending data to a target node via one communication interface selected from the plurality of communication interfaces; and second communication node capable of sending the data to the first communication node, with the one communication interface selected from the plurality of communication interfaces as a sending destination. The data communication program causes the computer to execute: a first conversion process in the first communication node for converting a sending source address of data to be sent to the target node into an address of the second communication node; and a second conversion process in the second communication node for converting a sending destination address of data received from the target node into an address of one communication interface selected from the plurality of communication interfaces.

Feature 8: In the data communication program according to the feature 7, the second conversion process in the second communication node includes converting the sending destination address of the data that satisfies a predetermined condition among the data received from the target node, into the address of the one communication interface selected from the plurality of communication interfaces.

Feature 9: In the data communication program according to the feature 7 or 8, the first conversion process in the first communication node includes converting the sending source address of the data to be sent to the target node into the address of the one communication interface selected from the plurality of communication interfaces, instead of the address of the second communication node.

In the present disclosure, the term “processor” may refer to a single hardware processor or several hardware processors that are configured to execute computer program code (i.e., one or more instructions of a program). In other words, a processor may be one or more programmable hardware devices. For instance, a processor may be a general-purpose or embedded processor and include, but not necessarily limited to, CPU (a Central Processing Circuit), a microprocessor, a microcontroller, and PLD (a Programmable Logic Device) such as FPGA (a Field Programmable Gate Array).

The term “memory” in the present disclosure may refer to a single or several hardware memory configured to store computer program code (i.e., one or more instructions of a program) and/or data accessible by a processor. A memory may be implemented using any suitable memory technology, such as static random-access memory (SRAM), synchronous dynamic RAM (SDRAM), nonvolatile/Flash-type memory, or any other type of memory. Computer program code may be stored on the memory and, when executed by a processor, cause the processor to perform the above-described various functions.

In the present disclosure, the term “circuit” may refer to a single hardware logical circuit or several hardware logical circuits (in other words, “circuitry”) that are configured to perform one or more functions. In other words (and in contrast to the term “processor”), the term “circuit” refers to one or more non-programmable circuits. For instance, a circuit may be IC (an Integrated Circuit) such as ASIC (an application-specific integrated circuit) and any other types of non-programmable circuits.

In the present disclosure, the phrase “at least one of (i) a circuit and (ii) a processor” should be understood as disjunctive (logical disjunction) where the circuit and the processor can be optional and not be construed to mean “at least one of a circuit and at least one of a processor”. Therefore, in the present disclosure, the phrase “at least one of a circuit and a processor is configured to cause the data communication system to perform functions” should be understood that (i) only the circuit can cause the data communication system to perform all the functions, (ii) only the processor can cause the data communication system to perform all the functions, or (iii) the circuit can cause the data communication system to perform at least one of the functions and the processor can cause the data communication system to perform the remaining functions. For instance, in the case of the above-described (iii), function A and B among the functions A to C may be implemented by a circuit, while the remaining function C may be implemented by a processor.

It is noted that a flowchart or the processing of the flowchart in the present application includes sections (also referred to as steps), each of which is represented, for instance, as a step. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A data communication system comprising:
a first communication node having a plurality of communication interfaces and capable of sending data to a target node via one communication interface selected from the plurality of communication interfaces; and
a second communication node capable of sending the data to the first communication node, with the one communication interface selected from the plurality of communication interfaces as a sending destination, wherein:
the first communication node has a first conversion processing unit that converts a sending source address of the data to be sent to the target node into an address of the second communication node; and
the second communication node has a second conversion processing unit that converts a sending destination address of the data received from the target node into an address of the one communication interface selected from the plurality of communication interfaces.

2. The data communication system according to claim 1, wherein:
the second communication node converts, by the second conversion processing unit, the sending destination address of the data that satisfies a predetermined condition among the data received from the target node, into the address of the one communication interface selected from the plurality of communication interfaces.

3. The data communication system according to claim 1, wherein:
the first communication node can convert, by the first conversion processing unit, the sending source address of the data to be sent to the target node into the address of the one communication interface selected from the plurality of communication interfaces, instead of the address of the second communication node.

4. The data communication system according to claim 1, further comprising:
at least one of (i) a circuit and (ii) a processor having a memory storing computer program code, wherein:
the at least one of the circuit and the processor having the memory is configured to cause the data communication system to provide at least one of: the first communication node; and the second communication node.

5. A data communication method for a data communication system including:
a first communication node having a plurality of communication interfaces and capable of sending data to a target node via one communication interface selected from the plurality of communication interfaces; and
a second communication node capable of sending the data to the first communication node, with the one communication interface selected from the plurality of communication interfaces as a sending destination,
the data communication method comprising:
a first conversion process in the first communication node for converting a sending source address of data to be sent to the target node into an address of the second communication node; and
a second conversion process in the second communication node for converting a sending destination address of data received from the target node into an address of one communication interface selected from the plurality of communication interfaces.

6. The data communication method according to claim 5, wherein:
the second conversion process in the second communication node includes converting the sending destination address of the data that satisfies a predetermined condition among the data received from the target node, into the address of the one communication interface selected from the plurality of communication interfaces.

7. The data communication method according to claim 5, wherein:
the first conversion process in the first communication node includes converting the sending source address of the data to be sent to the target node into the address of the one communication interface selected from the plurality of communication interfaces, instead of the address of the second communication node.

8. A non-transitory tangible computer readable storage medium comprising instructions being executed by a computer in a data communication system including:
a first communication node having a plurality of communication interfaces and capable of sending data to a target node via one communication interface selected from the plurality of communication interfaces; and
a second communication node capable of sending the data to the first communication node, with the one communication interface selected from the plurality of communication interfaces as a sending destination,
the instructions causing the computer to execute:
a first conversion process in the first communication node for converting a sending source address of data to be sent to the target node into an address of the second communication node; and
a second conversion process in the second communication node for converting a sending destination address of data received from the target node into an address of one communication interface selected from the plurality of communication interfaces.

9. The data communication program according to claim 8, wherein:
the second conversion process in the second communication node includes converting the sending destination address of the data that satisfies a predetermined condition among the data received from the target node, into the address of the one communication interface selected from the plurality of communication interfaces.

10. The data communication program according to claim 8, wherein:
the first conversion process in the first communication node includes converting the sending source address of the data to be sent to the target node into the address of the one communication interface selected from the plurality of communication interfaces, instead of the address of the second communication node.
